(19) United States
(12) Patent Application Publication
(10) Pub. No.: US 2015/0110427 A1
(43) Pub. Date: Apr. 23, 2015

(54) ROLLING BEARING ASSEMBLY HAVING MAGNETIC AND/OR ELECTRONIC ELEMENTS

(71) Applicants: Frank Berens, Saunay (FR); Stephane Cordier, Tours (FR); Olivier Verbe, Tours (FR)

(72) Inventors: Frank Berens, Saunay (FR); Stephane Cordier, Tours (FR); Olivier Verbe, Tours (FR)

(21) Appl. No.: 14/374,925

(22) PCT Filed: Jan. 26, 2012
(86) PCT No.: PCT/EP2012/051253

§ 371 Date: Dec. 8, 2014

(51) Int. Cl. F16C 33/66; F16C 41/00; F16C 19/06; F16C 33/60

(52) U.S. Cl. CPC F16C 33/6651; F16C 33/60; F16C 41/00; F16C 19/06
USPC 384/446; 384/490; 384/502; 384/473; 384/448

(57) ABSTRACT

A rolling bearing assembly includes an inner ring, an outer ring, at least one row of rolling elements disposed between raceways provided on the inner and outer rings, and an annular housing having at least one of the rings is arranged. The one ring includes two half ring parts, each half ring part having a radial portion and an inner and an outer axial cylindrical portions extending from the radial portion towards the outside. The inner axial cylindrical portion extend from the radial portion by a toroidal portion defining the raceway, each of the two half ring parts, defining with the annular housing, a closed space. A closed space or spaces can store lubricant and a passageway through at least one half ring part enables lubricant to pass from the closed space to the raceways. A magnetic and/or an electronic element is mounted inside at least one closed space.

### CROSS REFERENCE TO RELATED APPLICATION

This is a National Stage application claiming the benefit of International Application Number PCT/EP2012/051253 filed on 26 Jan. 2012, which is incorporated herein by reference in its entirety.

### TECHNICAL FIELD

The present invention relates to rolling bearings, in particular rolling bearings having an inner ring and an outer ring with one or more rows of rolling elements held by a cage between raceways provided in the two rings. The rolling elements may, for example, be balls. The rolling bearings may be, for example, those used in industrial electric motors or in motor vehicle gearboxes.

### BACKGROUND OF THE INVENTION

In such applications, the bearings are mainly loaded radially. The service life of the rolling bearing is essentially related to the lubrication of the bearing. Any defect in lubricating generally leads to rapid degradation and to failure of the rolling bearing.

For instance, a known deep groove ball bearing has two seals delimiting with the inner and outer rings a chamber inside which a lubricant such as grease has been introduced during the assembly of the bearing. Such a bearing is called lubricated “for life”. However, in the long term, the mixing of the grease, combined with its ageing and with the heating cycles that the bearing undergoes, cause the grease to degrade. It is possible to envisage periodic regreasing operations for this type of rolling bearings. However, these operations are expensive.

In order to avoid such periodic regreasing operations, FR-A1-2 923 277 discloses a rolling bearing comprising an inner ring and an outer ring with at least one row of rolling elements, and an annular housing surrounding the outer ring. Said outer ring is in two parts and each part forms with the housing a closed space, inside which grease or oil is located. The closed spaces function as a grease or oil reservoirs. Passage means for the lubricant are provided on the two parts of the outer ring for the lubricant to pass from the closed spaces towards the rolling elements. Such a rolling bearing is able to operate for a long time by virtue of internal lubrication.

However, lubricant migration from the closed spaces through holes thanks to gravity depends on the temperature and the vibrations in the rolling bearing, and is thus varying in time.

Furthermore, metallic pollution introduced inside the rolling bearing during its design or created by the friction between the raceways and the rolling elements during use, may damage the raceways.

### BRIEF DESCRIPTION OF THE INVENTION

It is a particular object of the present invention to provide a rolling bearing assembly having means for concentrating metallic pollution in a non-functional area and means for controlling some functioning bearing parameters such as the temperature and/or the vibration inside the rolling bearing assembly.

In one embodiment, the rolling bearing assembly comprises an inner ring, an outer ring, at least one row of rolling elements disposed between raceways provided on the inner and outer rings, and an annular housing inside which at least one of the rings is arranged. At least one a closed space is defined by at least one of the rings and the annular housing.

As an embodiment, the at least one of the rings arranged in the annular housing comprises two half ring parts. Each half ring part has a radial portion and an inner and an outer axial cylindrical portions extending from the radial portion towards the outside. The inner axial cylindrical portion extends from the radial portion by a toroidal portion defining the raceway. Each of the two half ring parts of said one ring defines with the annular housing, a closed space.

According to the invention, a magnetic and/or an electronic element is mounted inside at least one closed space.

Advantageously, at least one permanent magnet is mounted inside said closed space, at the vicinity of one of the raceways.

Such a rolling bearing assembly with a magnet allows concentrating metallic pollution, which can be introduced inside the rolling bearing during its design or created by the friction between the raceways and the rolling elements during use, in a non-functional area and increases the service life of the rolling bearing.

The permanent magnet can be mounted radially on an outer surface of the inner axial cylindrical portion of one half ring part and axially against the annular housing.

In an embodiment, a magnetic element is mounted inside both closed spaces.

In another embodiment, the electronic element is mounted on an outer surface of the toroidal portion of one of the half ring parts, opposite to the raceway of said half ring part.

In another embodiment, at least one of the closed spaces acting as a lubricant reservoir, the rolling bearing further comprising passage means for the lubricant to pass from the closed spaces to the raceways.

Advantageously, one closed space contains lubricant, and the other closed space contains the electronic element.

In an embodiment, at least one electronic element is mounted inside both closed spaces.

In another embodiment, one closed space contains lubricant, and the other closed space contains the magnetic element, or both closed spaces may contain a lubricant.

The electronic element may comprise a sensor fixed to the outer surface of the toroidal portion and communication means for communicating the information of the sensor towards the outside of the rolling bearing assembly. The sensor can be a vibration or a temperature sensor, in order to control the rolling bearing during use and to prevent degradation of the rolling bearing in case of high temperature or intensive vibrations inside the rolling bearing.

For example, the communication means comprise a wire or antenna passing through a hole provided on the annular housing.

Advantageously, the passage means comprise an axial trough-hole provided in the thickness of the radial portion of at least one half ring part of said one ring and a radial recess communicating with the axial through-hole.

In an embodiment, the annular housing comprises two distinct parts for retaining the half ring parts of said one ring.

### BRIEF DESCRIPTION OF DRAWINGS

The present invention will be better understood from studying the detailed description of a number of embodiments considered by way of entirely non-limiting examples and illustrated by the attached drawings in which:

FIG. 1 is an axial half-section of the rolling bearing according to a first embodiment of the invention;

FIG. 2 is an axial half-section of the rolling bearing according to a second embodiment;

FIG. 3 is an axial half-section of the rolling bearing according to a third embodiment; and

FIG. 4 is an axial half-section of the rolling bearing according to a fourth embodiment.

### DETAILED DESCRIPTION OF EMBODIMENTS OF THE INVENTION

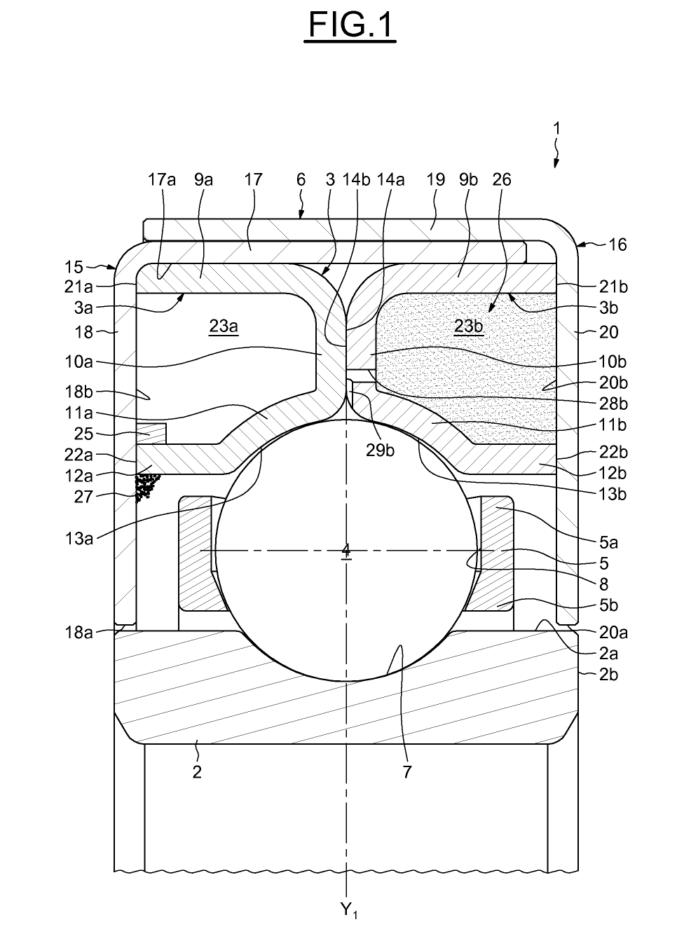

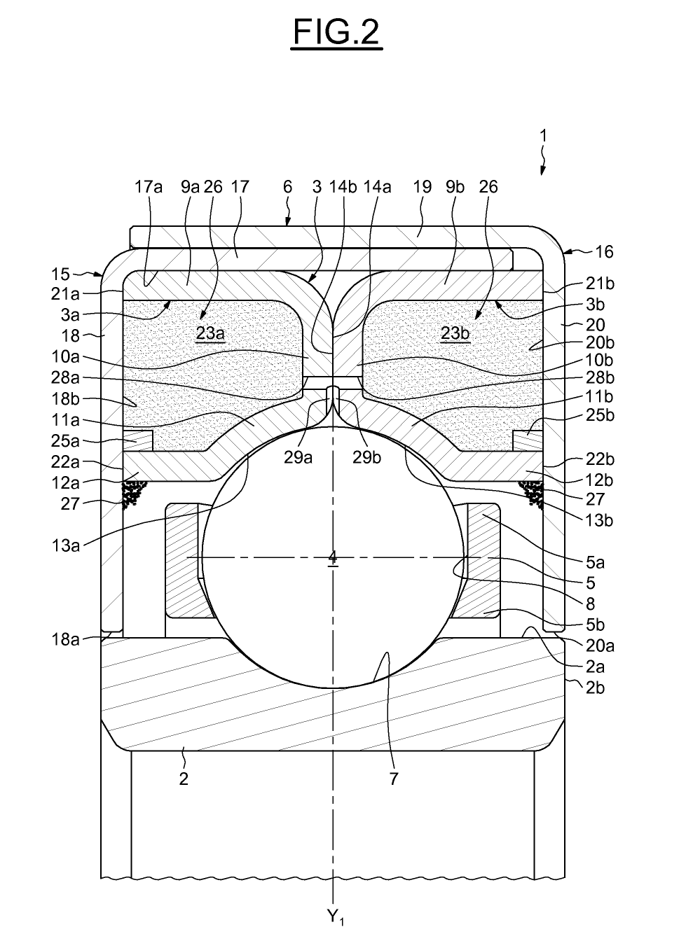

As illustrated on FIGS. 1 and 2, a rolling bearing assembly, designed by general reference number 1, comprises an inner ring 2, an outer ring 3, a row of rolling elements 4 consisting, in the example illustrated, of balls, held by a cage 5 between the inner ring 2 and the outer ring 3 and an annular housing 6 surrounding the outer ring 3.

The inner ring 2 is solid and has on its outer cylindrical surface 2a a toroidal groove 7, the radius of curvature of which is slightly greater than the radius of the rolling elements 4 and forms a bearing race for the rolling elements 4. The inner ring 2 may be manufactured by machining or by pressing a steel blank, which is then ground and optionally lapped at the bearing race 7 in order to give the ring 2 its geometrical characteristics and its final surface finish.

The cage 5 comprises a plurality of cavities 8 designed to house the rolling elements 4 and keep them uniformly circumferentially spaced. The cavities 8 are advantageously of spherical shape with a diameter slightly greater than that of the rolling elements 4. The cavities 8 are provided in the radial thickness of the cage 5 having a radial portion 5a radially facing the outer ring 3 and extending radially inwards by a conical portion 5b. The conical portion 5b is located radially facing the inner ring 2 and extends axially towards the rolling elements 4. The radial portion 5a and the conical portion 5b define the cavities 8. The conical portion 5b forms a guide portion for the rolling elements 4.

The outer ring 3 comprises two separate parts 3a, 3b or half ring parts. The half ring parts 3a, 3b are substantially identical and symmetric with respect to the axial plane of symmetry Y1 of the bearing 1, in order to reduce manufacturing costs. These two outer half ring parts 3a, 3b may advantageously be manufactured by cutting and stamping a metal sheet, the pieces obtained being then hardened by heat treatment. The bearing races intended for the rolling elements 4 may be ground and/or lapped in order to give them their geometric characteristics and their definitive surface finish. Since the two half ring parts 3a, 3b are substantially identical in this example, only one of them, having the reference “a” will be described here, it being understood that the identical elements of the other half ring part 3b bear the reference “b” in the figures.

The half ring part 3a of the outer ring 3 comprises an outer axial cylindrical portion 9a, a radial portion 10a, a toroidal portion 11a and an inner axial cylindrical portion 12a. The radial portion 10a is connected to the outer axial portion 9a and to the toroidal portion 11a. The toroidal portion 11a defines part of a raceway 13a for the rolling elements 4. The radius of curvature of the raceway 13a slightly exceeds the radius of the rolling elements 4. The toroidal portion 11a extends axially towards the outside of the rolling bearing 1 with the inner axial portion 12a. The two outer half ring parts 3a, 3b are arranged with the axially internal radial faces 14a, 14b of the radial portions 10a, 10b in contact.

In this embodiment, the housing 6, which is advantageously made of a stamped metal sheet, comprises two distinct annular parts 15, 16 surrounding the two outer half ring parts 3a, 3b so as to hold them firmly together in the axial direction. The parts 15, 16 of the housing 6 may advantageously be produced in an economical way from a single metal sheet by cutting and pressing. Each distinct part 15, 16 has an L-shaped structure.

The first part 15 comprises an inner axial cylindrical portion 17 for retaining radially said outer half ring parts 3a, 3b. The inner axial cylindrical portion 17 surrounds the outer half ring parts 3a, 3b and is in contact with the outer surface of the axial portions 9a, 9b of the outer half ring parts 3a, 3b. The first part 15 further comprises a radial flange 18 extending radially from the inner axial cylindrical portion 17 towards the immediate vicinity of the outer cylindrical surface 2a of the inner ring 2, so as to leave a clearance between the inner edge 18a of the radial flange 18 and the cylindrical surface 2a of the inner ring 2.

The second part 16 of the housing 6 comprises an outer axial cylindrical portion 19 surrounding the inner axial cylindrical portion 17 of the first part 15. The second part 16 further comprises a radial flange 20 extending radially from the outer cylindrical portion 19 towards the immediate vicinity of the outer cylindrical surface 2a of the inner ring 2, so as to leave a clearance between the inner edge 20a of the radial flange 20 and the outer cylindrical surface 2a of the inner ring 2. The outer axial cylindrical portion 19 is fixed to the inner axial cylindrical portion 17 by means of welding, brazing or glue.

As an alternative, the housing 6 may comprise a single part having an axial cylindrical portion and two radial flanges extending from the axial cylindrical portion towards the inner ring.

The half ring parts 3a, 3b are centred in the inner axial portion 17 of the part first 15 of the housing 6 by contact between the axial portions 9a, 9b and the inner bore 17a of the said inner axial portion 17. The outer radial faces 21a, 21b which form the outer edges of the outer axial portions 9a, 9b are respectively in contact with the inner surface 18b, 20b of the radial flanges 18, 20 of the parts 15, 16 of the housing 6, thus axially clamping the two half ring parts 3a, 3b together. The outer radial faces 22a, 22b which form the outer edges of the inner axial portions 12a, 12b are also in contact with said inner surface 18b, 20b of the radial flanges 18, 20.

As an alternative, an axial clearance (not shown) may be provided between the outer edges 22a, 22b of the inner axial portions 12a, 12b and the inner surface 18b, 20b of the radial flanges 18, 20 of the housing 6.

Each of the half ring parts 3a, 3b defines, with the housing 6, an annular closed space 23a, 23b. More specifically, the closed space 23a is delimited by the outer axial portion 9a, the radial portion 10a, the toroidal portion 11a, and the inner axial portion 12a, and, adjacent to these portions, the radial flange 18 of the first part 15 of the housing 6.

As illustrated on FIG. 1, the rolling bearing assembly 1 further comprises a magnetic element 25 mounted inside one of the closed spaces 23a, at the vicinity of the corresponding raceway 13a. The magnetic element 25 is a permanent magnet mounted radially on the outer surface of the inner axial cylindrical portion 12a of one half ring part 3a and axially against the inner surface 18b of the radial flange 18 of the housing 6.

As illustrated, only one of the two closed spaces 23b may act as a lubricant reservoir, the lubricant 26 contained in this closed space 23b may be grease or oil, and the other closed space 23a contains the magnetic element 25.

The half ring part 3b of the outer ring 3 comprises passage means 24b. In the example illustrated on FIG. 1, this passage means 24b comprises at least one and preferably a plurality of axial through-holes 28b provided in the thickness of the radial portion 10b of the half ring part 3b containing lubricant 26. The axial through-hole 28b communicates with a radial recess or groove 29b, which open toward its internal end so as to leave passage for the lubricant 26 to flow into the row of rolling elements 4 and between the respective contact surfaces of the rolling elements with the raceways 13a, 13b.

The magnetic element 25 allows attracting metallic particles 27 against the inner axial cylindrical portion 12b, in order to prevent these particles to damage the raceways 13a, 13b of the rolling bearing 1. Metallic particles may be created by friction between raceways and the rolling elements or can appear from the outside, for example during use in a high friction environment or during machining of the rolling bearing.

As an alternative, the half ring part can be provided with no passage means when an axial clearance (not shown) is provided between the outer edges 22a, 22b of the inner axial portions 12a, 12b and the inner surface 18b, 20b of the radial flanges 18, 20 of the housing 6 or, when grease is used directly onto the rolling elements.

However, alternatively, other types of passage means for the lubricant contained in the corresponding closed space 23b may be used.

For example, a radial through-hole (not represented) may be provided in the thickness of the inner cylindrical axial portion 12a, 12b of the outer half ring part 3b. Such a radial through-hole allows the lubricant 26 contained in said closed space 23b to flow by gravity directly towards the rolling elements 4.

As illustrated in FIG. 2, a magnetic element 25a, 25b is mounted in each closed spaces 23a, 23b, and both closed spaces 23a, 23b act as a lubricant reservoir.

In this embodiment, the passage means comprise at least one and preferably a plurality of axial through-holes 28a, 28b provided in the thickness of the radial portions 10a, 10b of each half ring part 3a, 3b. Each axial through-hole 28a, 28b communicates with a radial recess or groove 29a, 29b which open toward its internal end so as to leave passage for the lubricant to flow into the row of rolling elements 4 and between the respective contact surfaces of the rolling elements with the raceways 13a, 13b. As illustrated, the axial through-holes 28a, 28b at least partly face one another, so as to put the two closed spaces 23a, 23b into communication. As an alternative, the axial through-holes may not be facing one another.

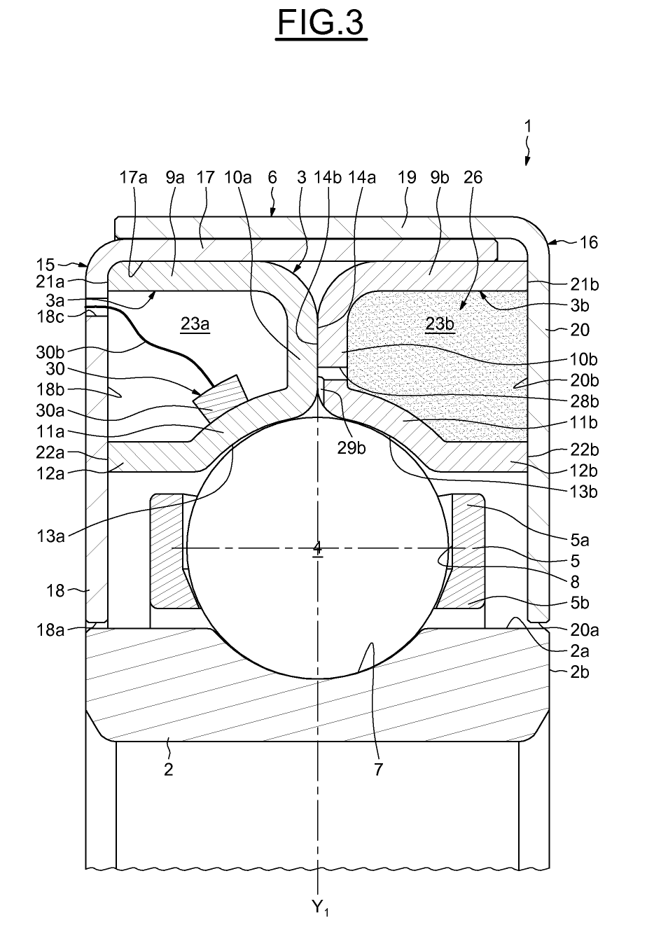

The embodiments of FIGS. 3, in which identical elements bear the same references, differs from the embodiment of FIG. 1 only by the fact that an electronic element 30 is mounted inside one of the closed spaces 23a.

In this embodiment, the electronic element 30 is mounted on an outer surface of the toroidal portion 11a of one of the half ring parts 3a, opposite to the raceway 13a of the corresponding half ring part 3a.

The electronic element 30 comprises a sensor 30a fixed to the outer surface of the toroidal portion 11a and communication means 30b for communicating the information of the sensor 30a towards the outside of the rolling bearing assembly 1. The sensor can be, for example, a temperature sensor, a vibration sensor . . . . As illustrated, the communication means 30b comprise a wire passing through an axial through-hole 18c provided on the housing 6. As an alternative, communication means 30b can be wireless or comprise an antenna having an end attached to the sensor 30a and the other end at the periphery of the housing 6.

In this embodiment, only one of the two closed spaces 23b may act as a lubricant reservoir, the lubricant 26 contained in this closed space 23b may be grease or oil, and the other closed space 23a contains the electronic element 30.

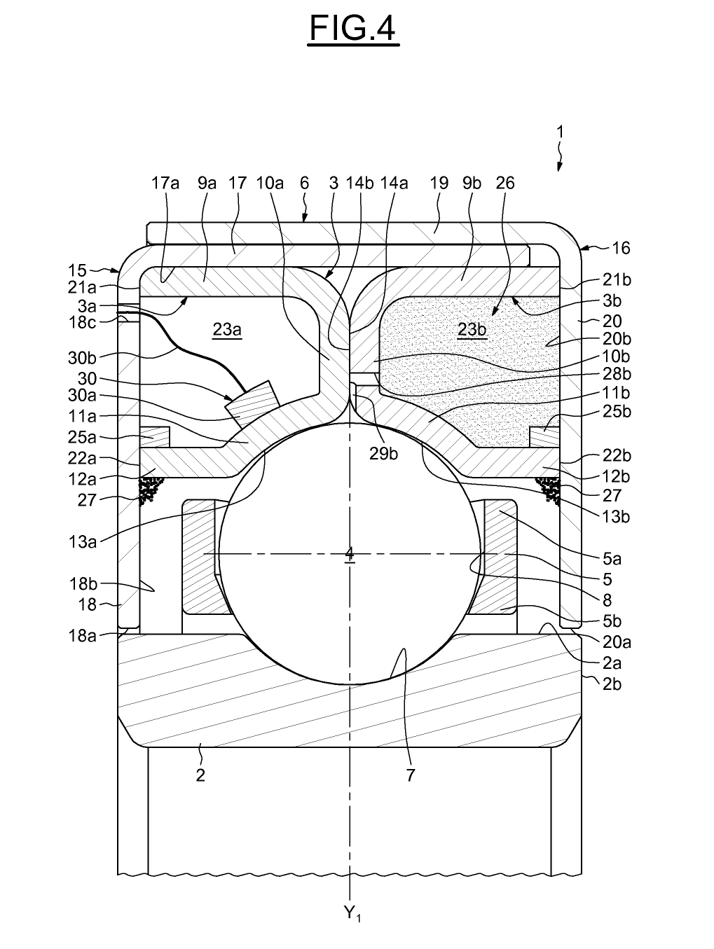

The embodiment of FIG. 4, in which identical elements bear the same references, differs from the embodiment of FIG. 2, in that one closed space 23a comprises a magnetic element 25a and an electronic element 30 having a sensor 30a and communication means 30b. The other closed space 23b contains another magnetic element 25b and act as lubricant reservoir for a lubricant 26.

The invention can also be applied to rolling bearings having a housing surrounding the inner ring. In that case, it is the outer ring that is solid while the two half ring parts forming the inner ring are produced by stamping a metal sheet. The arrangement is identical to that of the embodiment of FIGS. 1 to 6, but with the elements inverted.

The invention can also be applied to rolling bearings in which the inner ring and the outer ring are both surrounded by an annular housing. In that case, the two rings have the same structure. In other words, the inner ring is surrounded by a first annular housing and the outer ring is surrounded by a second annular housing.

The specific features and characteristics mentioned for each of the embodiments could be applied without major modification to the other embodiments. Moreover, although the present invention has been illustrated using single-row ball bearings, it will be understood that the invention can be applied without major modification to bearings using rolling elements that are not balls and/or that have several rows of rolling elements. Alternatively, the inner ring could comprise two half ring parts and be surrounded by a housing having two distinct parts as described above.

Thanks to the rolling bearing described above, the closed spaces may be used for housing other elements than lubricant without adding additional dimension to the rolling bearing.

Furthermore, thanks to the magnetic and electronic elements, the service life of the rolling bearing assembly is increased. Indeed, the magnetic elements allow attracting metallic particles in order to prevent these particles to damage the raceways, and the electronic element allows to detect any failure of the rolling bearing, such as an increase in temperature due to a lubrication problem, which may increase friction between raceways and the rolling elements and thus create metallic particles which are immediately collected by the magnetic element.

1. A rolling bearing assembly comprising:
an inner ring,
an outer ring,
at least one row of rolling elements disposed between raceways provided on the inner and outer rings, and
an annular housing having at least one of the rings arranged therein, said one ring and said annular housing defining at least one closed space, wherein at least one of a magnetic and an electronic element is mounted inside said at least one closed space.

2. The rolling bearing assembly according to claim 1, wherein the ring arranged within the annular housing comprises two half ring parts making at least one of the rings, each half ring part having a radial portion and an inner and an outer axial cylindrical portions extending from the radial portion towards the outside, the inner axial cylindrical portion extending from the radial portion by a toroidal portion defining the raceway.

3. The rolling bearing according to claim 1, in which at least one of closed spaces acts as a lubricant reservoir and at least one half ring part comprises a passage for the lubricant to pass from the closed space to the raceways.

4. The rolling bearing assembly according to claim 1, in which at least one permanent magnet is mounted inside said closed space, at the vicinity of one of the raceways.

5. The rolling bearing assembly according to claim 5, in which the permanent magnet is mounted radially on an outer surface of the inner axial cylindrical portion of one half ring part and axially against the annular housing.

6. The rolling bearing assembly according to claim 2, wherein one closed space contains lubricant, and the other closed space contains the magnetic element.

7. The rolling bearing assembly according to claim 2, wherein both closed spaces contain a lubricant.

8. The rolling bearing assembly according to claim 1, wherein a magnetic element is mounted inside both closed spaces.

9. The rolling bearing assembly according to claim 1, wherein the electronic element is mounted on an outer surface of the toroidal portion of one of the half ring parts, opposite to the raceway of said half ring part.

10. The rolling bearing assembly according to claim 9, wherein one closed space contains lubricant, and the other closed space contains the electronic element.

11. The rolling bearing assembly according to claim 9, wherein the electronic element comprises a sensor fixed to the outer surface of the toroidal portion and a communication element for communicating the information of the sensor towards the outside of the rolling bearing assembly.

12. The rolling bearing assembly according to claim 12, wherein the communication element comprises one of a wire or antenna passing through a hole provided on the annular housing.

13. The rolling bearing assembly according to claim 1, wherein the passage comprises an axial trough-hole provided in the thickness of the radial portion of at least one half ring part of said one ring and a radial recess communicating with the axial through-hole.

14. The rolling bearing assembly according to claim 1, wherein the annular housing comprises two distinct parts for retaining the half ring parts of said one ring.
